(19) United States
(12) Patent Application Publication
(10) Pub. No.: US 2020/0343066 A1
(43) Pub. Date: Oct. 29, 2020

(54) ELECTRICAL CONTACT ASSEMBLY USING SILVER GRAPHITE

(71) Applicant: SENSATA TECHNOLOGIES, INC., ATTLEBORO, MA (US)

(72) Inventors: JEROEN W.H. KORTE, ALMELO (NL); CHENGYONG XIA, CHANGZHOU (CN)

(21) Appl. No.: 16/394,914

(22) Filed: Apr. 25, 2019

(51) Int. Cl. H01H 45/14; H01H 61/01; H01H 33/02; H01H 49/00

(52) U.S. Cl. CPC H01H 45/14; H01H 49/00; H01H 33/025; H01H 61/01

(57) ABSTRACT

According to one embodiment, an electrical contact assembly is disclosed. The assembly includes a layer of a conducting metal, a layer of copper adjacent to the layer of conducting metal, and a face layer comprising silver graphite adjacent to the layer of copper.

### FIELD OF THE INVENTION

The present disclosure relates to electronics. More particularly, this disclosure relates to electrical contacts.

### BACKGROUND OF THE INVENTION

There are many types of electronics that utilize electrical contacts. Exemplary uses include motors, switches, generators, and the like. An issue that can occur with electronics is that electrical contacts might eventually wear out. Contact wear occurs because contacts are regularly rubbing against other contacts and other surfaces. During a transition (such as between the contacts being open and the contacts being closed or vice versa), a microscopic molten bridge forms and eventually ruptures asymmetrically, transferring contact material between contacts and increasing the surface roughness. An electric arc occurs between the contact points during transition from open to close when the contact gap is below a threshold and the voltage is high enough. Heating due to arcing and high current density can melt the contact surface temporarily. If some of the melting material solidifies while the contacts are closed, the contact may stick closed due to a micro-weld between the contacts. The arc caused during the break between contacts is similar to arc welding, as the break arc is typically more energetic and more destructive. The arc can cause material transfer between contacts and may be hot enough to evaporate metal from the contact surface.

Thus, contact wear can include material transfer between contacts, loss of contact material due to splatter, evaporation, oxidation, or corrosion of the contacts due to high temperatures and atmospheric influences. Failure of the electrical contact can result in a failure of the electronics, and even result in potential safety issues.

### SUMMARY OF THE INVENTION

According to one embodiment, an electrical contact assembly is disclosed. The assembly includes a layer of a conducting metal, a layer of copper adjacent to the layer of conducting metal, and a face layer comprising silver graphite adjacent to the layer of copper.

According to another embodiment, a thermal overload relay is disclosed. The thermal overload relay includes a first contact assembly comprising: a layer of a conducting metal; a layer of copper adjacent to the layer of conducting metal; and a face layer comprising silver graphite adjacent to the layer of copper. In this embodiment, the thermal overload relay also includes a second contact assembly comprising: a layer of a conducting metal; a layer of copper adjacent to the layer of conducting metal; and a face layer adjacent to the layer of copper. The thermal overload relay also includes a bimetal coupled to either the first contact assembly or the second contact assembly and a heating element configured to adjust a current sensitivity of the bimetal.

In another embodiment, a method of forming a contact assembly is disclosed. The method includes combining silver and graphite to form a silver graphite compound in solid form. According to this embodiment, the method also includes creating graphite free portion of silver graphite compound. The method also includes combining the silver graphite compound with a layer of copper and a layer of a conducting metal.

The foregoing and other objects, features, and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

So that those having ordinary skill in the art to which the disclosed technology appertains will more readily understand how to make and use the same, reference may be had to the following drawings.

FIG. 1 shows an illustrative cutaway view of a contact assembly of one or more embodiments;

FIG. 2 shows an illustrative perspective view of a contact assembly of one or more embodiments;

FIGS. 3A, 3B, and 3C show graphs demonstrating the end of life characteristics of one or more embodiments; and

FIG. 4 is a flow diagram illustrating an exemplary process for forming a contact assembly of one or more embodiments.

### DETAILED DESCRIPTION

The present disclosure describes a material composition that can be used for electrical contacts.

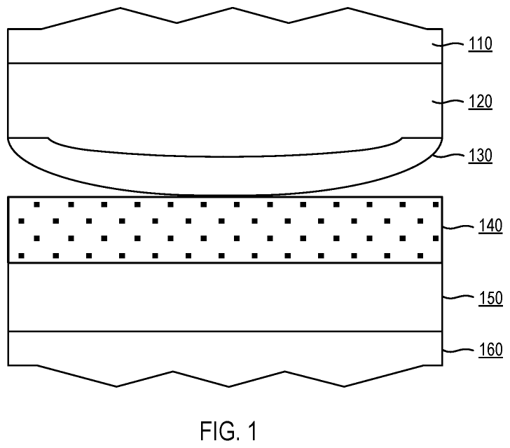

FIG. 1 is an illustrative cutaway view of two electrical contact assemblies containing embodiments of the present disclosure. Two electrical contacts are present in FIG. 1, a top contact assembly and a bottom contact assembly. It should be understood that the terms top and bottom are merely for illustrative purposes. Embodiments of the present disclosure can be used in a variety of different orientations. Those of skill in the art will understand that the electrical contacts of FIG. 1 can be used in a variety of different electrical devices, such as in electric motors, electric switches, relays, and the like.

In the example of FIG. 1, the top contact assembly comprises layers 110, 120, and 130. Steel layer 110 allows for easier welding of the contacts, using techniques such as electrical welding or laser welding. Steel layer 110 can be coupled to other material of the electrical device in which the electrical contacts are placed, as will be shown in later figures.

Layer 120 is a layer of copper that is adjacent to layer 110. The copper allows for high heat transfer and heat dissipation away from layer 130 towards steel layer 110 and the rest of the electrical device. A disadvantage of copper is that copper has a high resistance when it is oxidized. Because an electrical contact has a high probability of oxidation due to the reasons set forth above, this makes copper a non-optimal material to use as the face layer.

Layer 130 is the face layer that is adjacent to layer 120. Layer 130 may comprise a composite of silver. For example, a silver graphite. Example silver graphite composites can include AgC3, AgC4, or AgC5. Alternatively, a silver graphene material may be used. Other alternative materials may include AgNi03, AgNi10, and AgSnO2.

Layers 140 through 160 represent another contact assembly. As such, in some embodiments, layers 140 through 160 contain the same materials as layers 110 through 130. For example, layer 140 is a face layer and may comprise a silver composite. Layer 150 may be a copper layer. Layer 160 may be a steel layer. In other embodiments, layer 140 may have a slightly different composition from layer 130. For example, while layer 130 may be a silver graphite, layer 140 may be a silver graphene. In a similar manner layer 150 may have a slightly different composition from layer 120 and layer 160 may have a different composition from layer 110.

The principle behind the above-described contact assembly is based on a symmetrical or unsymmetrical contact material pair. Each contact of the contact pair comprises three-layers in an atmosphere of air. A silver graphite contact material (such as layers 130 and 140) exhibits an extremely high resistance to contact welding. However, silver graphite also has a low resistance to arc erosion, which is caused by the reaction of graphite with the oxygen in the surrounding atmosphere at the high temperatures created by the arcing. The weld resistance is especially high for materials with the graphite particle orientation that is parallel to the arcing contact surface. Because the contact surface after arcing comprises of pure silver, the contact resistance stays low during the electrical life of the contact parts.

During use, the contact face layers 130 and 140 with silver graphite interface with each other. Eventually, contact wear will reduce one of contact face layers 130 or 140 to the point where it is worn out completely. Thereafter, the copper layer that is adjacent to the contact face layer (such as layer 120 or layer 150, depending on which of the contact face layers wore out first) becomes the layer that interfaces with the other contact assembly. The copper will oxidize into copper oxide. The copper oxide has a high contact resistance that prevents current from flowing through the contacts. While that could render unusable the electrical device in which the contact is placed, the prevention of flowing current protects the electrical device in which the contact assembly is being used.

Using silver graphite on the face layer (such as contact face layers 130 and 140) will avoid contact welding, which is an undesired and un-safe state. Silver graphite will react on the electric cycling. During the cycle, the contact surface area will be imposed to an arc and the carbon in the silver graphite will be reacting with oxygen to form carbon dioxide. This will leave holes in the silver graphite face layer, creating a sponge-like structure. This sponge-like structure will be easier to break and therefor prevents the contacts from welding with each other.

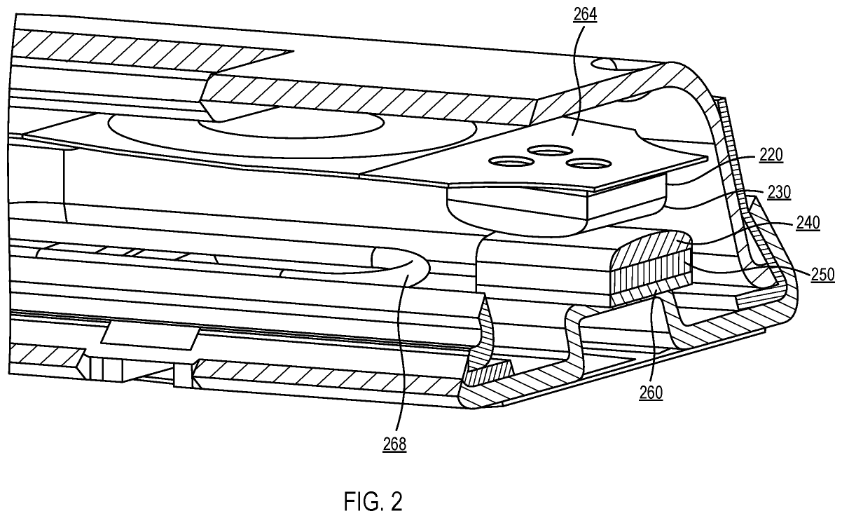

FIG. 2 presents an illustrative perspective view of a contact assembly according to embodiments of the present disclosure. In FIG. 2, contact assembly is being used in a thermal overload relay, designed to protect an electric device (such as an electric motor). The layers 220 and 230 are similar to layers 120 and 130 from FIG. 1. A layer corresponding to layer 110 from FIG. 1 also may be present, though it is not visible in FIG. 2. In other words, a steel layer (not shown) is adjacent to element 264. Coupled to the steel layer is a copper layer 220. Coupled to the copper layer 220 is a silver graphite layer 230. Layers 240, 250, and 260 are similar to layers 140, 150, and 160 from FIG. 1. In other words, a steel layer 260 is coupled to a copper layer 250, which is coupled to a silver graphite layer 240.

The thickness of the various layers can vary. In some embodiments, the face layer (layers 230 and 240) can be approximately 150 micrometers (μm), with a total thickness of all three layers (e.g., layers 240, 250, and 260) of approximately 800 μm. Other embodiments can use correspondingly thinner layers. In one embodiment, the face layer can have a thickness of approximately 60 μm. In other embodiments, the thickness of the face layer may be 30 μm.

Also present in FIG. 2 are bimetal 264 and heating element 268. The elements provide the thermal overload protection in the embodiment shown in FIG. 2. Bimetal 264 can serve as the mechanical temperature sensor. In operation, bimetal 264 comprises two different metals with different thermal expansion properties. As bimetal 264 is heated, the two different metals lengthen at different rates, causing bending of the bimetal and eventually forcing the top contact assembly to the bottom contact assembly, tripping the thermal overload relay to protect the electric device to which the thermal overload relay is coupled.

Heating element 268 serves to ensure that the bimetal 264 is more current sensitive. By heating the bimetal 264, the thermal overload relay is less sensitive to ambient temperature. Thus, the thermal overload relay is more reactive to the current being sensed.

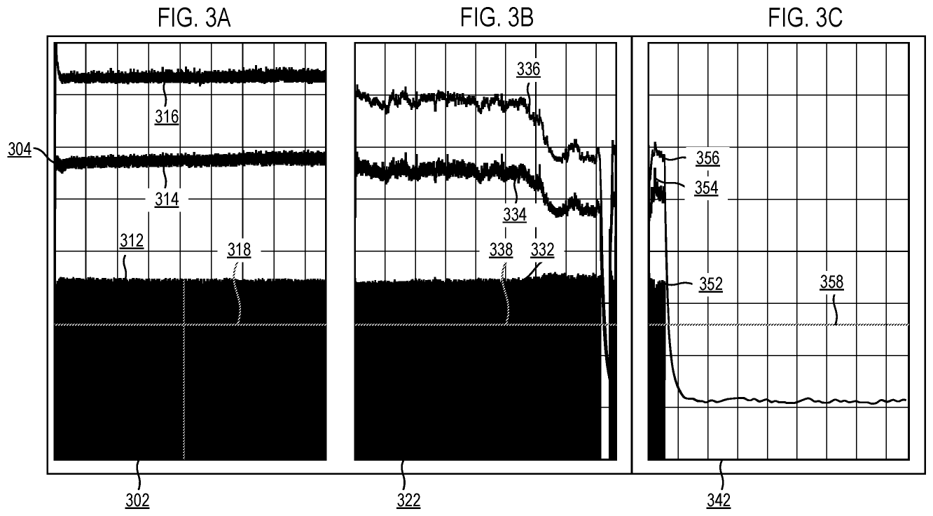

FIGS. 3A through 3C are graphs illustrating the operation of one or more embodiments. As described above, a non-symmetric pair of contacts can be used in one or more embodiments. In a non-symmetric pair only one of the contact faces comprises silver graphite. In the examples shown in FIGS. 3A through 3C, one of the contact pairs includes silver graphite. The other of the contact comprise a silver nickel contact face such as AgNi0.3.

In FIGS. 3A-3C, the operation of an electric motor being protected by a thermal overload relay containing one or more embodiments is illustrated. In this embodiment, the thermal overload relay is being used to protect an electric motor. In the graphs, the x-axis 302, 322, and 342 represent time. The y-axis 304 represents voltage, current, and temperature. FIG. 3A represents the operation of the prototype in normal operation. Current through the electric motor is represented by graph element 312. The brush temperature through the electric motor is represented by element 314. The winding temperature through the electric motor is represented by element 316. Voltage through the electric motor is represented by element 318.

FIG. 3B represents the operation of the prototype electric motor as the motor approaches the end of its service life. Current is represented by graph element 332. The brush temperature is represented by graph element 334. The winding temperature is represented by graph element 336. Voltage is represented by graph element 338. As can be seen near the right side of FIG. 3B, the current represented by graph element 332 goes down to zero, signifying that no current is flowing through the electric motor because the thermal overload relay became activated. When the current goes to zero, the temperature of the winding and brush also drops.

FIG. 3C represents the operation of the prototype electric motor at the end-of-life of the motor. Current is represented by graph element 352. The brush temperature is represented by element 354. The winding temperature is represented by element 356. Voltage is represented by element 358. Near the beginning of the graph of FIG. 3C, the prototype electric motor experiences a failure. Thereafter, the thermal overload relay is activated. The result is that current 352 no longer flows and the brush temperature 354 and the winding temperature 356 drastically reduce. Lowering the temperature of the windings and the brush of the electric motor being protected prevents several possible problems that can occur with the failure of an electric motor, including fire, melted parts, electrical shorts, and the like.

The silver graphite in the face layer (such as layer 130) can have a variety of different compositions. In some embodiments, the face layer can have a composition of between 2.5% and 5% silver graphite. For example, an embodiment may include 97% silver with 3% silver graphite.

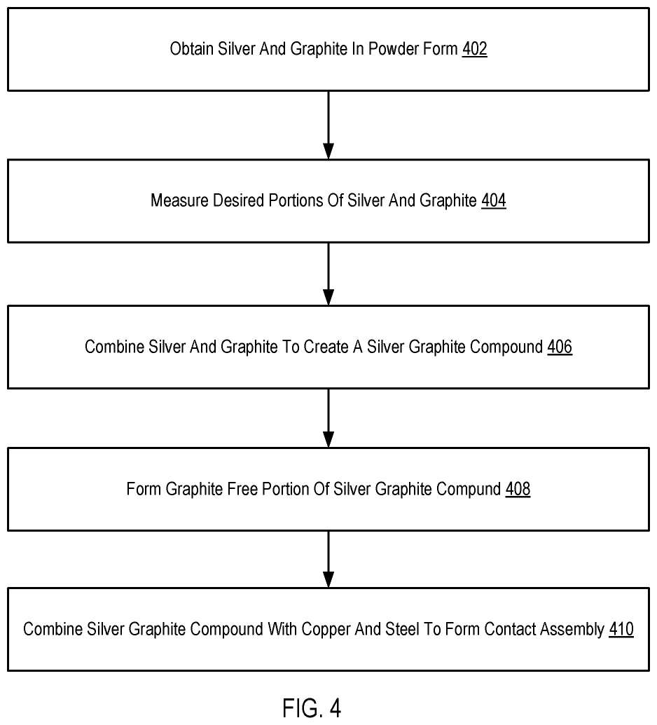

The silver graphite contact assembly can be formed in a variety of different manners. With reference to FIG. 4, a method of forming a contact assembly in one or more embodiments is presented. Silver and graphite materials are obtained in a powder form (block 402). The desired proportion of silver and graphite is measured (such as 2 to 5 percent graphite by weight) (block 404). Silver and graphite are then combined to form the AgC compound (block 406). This can be done using one of several different techniques. A pressing-sintering-repressing is one such technique. The powders are placed into a mold and placed under pressure, such as through the use of a hydraulic press. Thereafter, sintering occurs by raising the temperature of the pressed powder (usually below the melting point of the compound) for a predetermined amount of time. Thereafter, the sintered material is pressed again. In some embodiments, an extrusion process is used. In hot extrusion, the powder is heated and pushed through a die to form the desired shape. In some embodiments, a graphite free bottom portion of the compound is formed (block 408), for ease of welding the silver graphite to the remainder of the contact assembly. This can be performed by burning out the graphite on one side of the compound or by extruding the silver graphite and covering a portion with a fine silver shell. The silver graphite can then be welded or brazed to a copper layer, which is then welded or brazed to a layer of a conducting metal, such as steel (block 410). Thereafter, the contact assembly has been formed and can be used in any application in which contacts with its characteristics are desired.

The advantages, and other features of the systems and methods disclosed herein, will become more readily apparent to those having ordinary skill in the art from the following detailed description of certain preferred embodiments taken in conjunction with the drawings which set forth representative embodiments of the present invention. Like reference numerals are used herein to denote like parts. Further, words defining orientation such as “upper”, and “lower” are merely used to help describe the location of components with respect to one another. For example, an “upper” surface of a part is merely meant to describe a surface that is separate from the “lower” surface of that same part. No words denoting orientation are used to describe an absolute orientation (i.e., where an “upper” part must always be on top).

It will be appreciated by those of ordinary skill in the pertinent art that the functions of several elements may, in alternative embodiments, be carried out by fewer elements or a single element. Similarly, in some embodiments, any functional element may perform fewer, or different, operations than those described with respect to the illustrated embodiment. Also, functional elements shown as distinct for purposes of illustration may be incorporated within other functional elements in a particular implementation.

While the subject technology has been described with respect to preferred embodiments, those skilled in the art will readily appreciate that various changes and/or modifications can be made to the subject technology without departing from the spirit or scope of the subject technology. For example, each claim may be dependent from any or all claims in a multiple dependent manner even though such has not been originally claimed.

What is claimed is:

1. An electrical contact assembly comprising:
a layer of a conducting metal;
a layer of copper adjacent to the layer of conducting metal; and
a layer comprising silver graphite adjacent to the layer of copper.

2. The electrical contact assembly of claim 1, wherein the layer of silver graphite comprises graphite in the range of 2.5 percent to 5 percent.

3. The electrical contact assembly of claim 1, wherein the layer of silver graphite comprises 3 percent graphite.

4. The electrical contact assembly of claim 1, wherein
the silver graphite is optimized to react with atmospheric air to form carbon dioxide when exposed to an electric arc, resulting in a substance that is more resistant to welding.

5. The electrical contact assembly of claim 1, wherein the layer of conducting metal comprises a layer of steel.

6. The electrical contact assembly of claim 1, wherein a thickness of the contact assembly is approximately 800 micrometers.

7. The electrical contact assembly of claim 1, wherein a thickness of the silver graphite layer is approximately 150 micrometers.

8. The electrical contact assembly of claim 1, wherein a thickness of the silver graphite layer is approximately 60 micrometers.

9. A thermal overload relay comprising:
a first contact assembly comprising:
a layer of a conducting metal;
a layer of copper adjacent to the layer of conducting metal; and
a face layer comprising silver graphite adjacent to the layer of copper;
a second contact assembly comprising:
a layer of a conducting metal;
a layer of copper adjacent to the layer of conducting metal; and
a face layer adjacent to the layer of copper;
a bimetal coupled to either the first contact assembly or the second contact assembly; and
a heating element configured to adjust a current sensitivity of the bimetal.

10. The thermal overload relay of claim 9, wherein the layer of silver graphite comprises graphite in the range of 2.5 percent to 5 percent.

11. The thermal overload relay of claim 9, wherein the layer of silver graphite comprises 3 percent graphite.

12. The thermal overload relay of claim 9, wherein
the silver graphite is optimized to react with atmospheric air to form carbon dioxide when exposed to an electric arc, resulting in a substance that is more resistant to welding.

13. The thermal overload relay of claim 9, wherein the layer of conducting metal comprises a layer of steel.

14. The thermal overload relay of claim 9, wherein a thickness of the contact assembly is approximately 800 micrometers.

15. The thermal overload relay of claim 9, wherein a thickness of the silver graphite layer is approximately 150 micrometers.

16. The thermal overload relay of claim 9, wherein a thickness of the silver graphite layer is approximately 60 micrometers.

17. A method of forming a contact assembly, the method comprising:
combining silver and graphite to form a silver graphite compound in solid form;
creating graphite free portion of silver graphite compound; and
combining the silver graphite compound with a layer of copper and a layer of a conducting metal.

18. The method of claim 17 wherein combining silver and graphite to form a silver graphite compound comprises using a hot extrusion process to form the silver graphite compound.

19. The method of claim 17 wherein combining silver and graphite to form a silver graphite compound comprises using a sintering and pressing process to form the silver graphite compound.

20. The method of claim 17 wherein combining the silver graphite compound with the layer of copper and the layer of a conducting metal comprises using a brazing or welding process to join the silver graphite compound with the layer of copper and the layer of conducting metal.
